(19) United States
(12) Patent Application Publication
(10) Pub. No.: US 2007/0174229 A1
(43) Pub. Date: Jul. 26, 2007

(54) Real time wireless informational services

(76) Inventor: Samir Adil Ismail, Dublin, CA (US)

Correspondence Address: O'BANION & RITCHEY LLP/ SONY ELECTRONICS, INC., 400 CAPITOL MALL, SUITE 1550, SACRAMENTO, CA, 95814, US

(21) Appl. No.: 11/442,006

(22) Filed: May 26, 2006

Related U.S. Application Data
(60) Provisional application No. 60/761,508, filed on Jan. 24, 2006.

(51) Int. Cl. G06F 7/00

(52) U.S. Cl. 707/1

(57) ABSTRACT

A system and method mines data from wireless clients and converts this individual or cumulative data gathered into information relevant to the same segment of clients. The system includes several wireless clients subscribing to a service, a server mechanism that gathers, analyzes and returns relevant information back to the subscribing clients. Nonsubscribers also may send data and receive information. The clients use mobile wireless telephones to communicate with the server. The method includes managing the lifecycle of data and key trigger mechanisms that are significant to the user experience.

### CROSS-REFERENCE TO RELATED APPLICATIONS

This application claims priority to U.S. provisional application Ser. No. 60/761,508, filed on Jan. 24, 2006, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of Invention

This invention pertains generally to wireless informational services, and more particularly to wireless real time data mining from and delivery of time sensitive data derived therefrom to individuals or groups.

2. Description of Related Art

Today, the masses of wireless users receive informational services whose producers account to a single person, a group of people or a company. The timing of this information is also masked by a sequence of delays. What is not tapped is the data being created by the masses themselves in each and every moment as they participate individually in many significant events on a daily basis. As the mobile phone has penetrated the masses, it would be desirable to mobilize this data, which when analyzed individually or cumulatively, could provide key information for the masses of wireless users.

For example, it would be useful to obtain vehicle speed and location coordinates from drivers in cars. If this data is analyzed cumulatively from many drivers, traffic congestion patterns can be deciphered. Information could be transmitted back to individual drivers depending on their location. Of course, the information would only be valuable if it is received in a time frame when the traffic conditions exist. Devices attached to such services could then engage in discovering a new route to gain efficiency in time of travel.

In another scenario, it would be advantageous for a company to better serve its customers by providing wait time information. For example, when a customer enters an airline ticketing queue, it would be useful to collect information about the time it takes the customer to reach the ticketing counter. The information could then be provided to incoming customers who can plan to allot the necessary time and/or the information could be used by airline management to make decisions about closing or opening ticketing counters. Again, the timing of the information is critical to its value.

The commonality between these scenarios is the need to collect data from the sources. This becomes feasible because the data sources can be the common wireless users. The user could be a subscriber of a particular service with the necessary equipment related to it, or the user could be just a customer of a company and happens to be a wireless user. Today, this unique data source is completely untapped.

Accordingly it is desirable to provide a system that uses mobile phones to penetrate the masses, to mobilize or collect real time data from them, to analyze the data individually or cumulatively, and to provide time sensitive key information based thereon to the masses of wireless users.

### BRIEF SUMMARY OF INVENTION

Accordingly, an aspect of the invention is a method of obtaining real time source data from one or more mobile sending wireless clients who are approaching or engaged in a particular ongoing event; processing the real time source data obtained from the one or more mobile sending wireless clients to produce valuable information relating to the ongoing event; and sending the valuable information to one or more mobile receiving wireless clients to use in making decisions about the ongoing event.

Another aspect of the invention is an apparatus comprising a plurality of mobile wireless clients, one or more of which configured to send real time source data about a particular ongoing event; and a server which is configured to receive the source data sent by the one or more clients, process the source data to produce valuable information relating to the ongoing event, and send the valuable information to one or more mobile wireless clients to use in making decisions about the ongoing event.

A further aspect of the invention is an apparatus comprising means for obtaining real time source data from one or more mobile sending wireless clients who are approaching or engaged in a particular ongoing event; means for processing the real time source data obtained from the one or more mobile sending wireless clients to produce valuable information relating to the ongoing event; and means for sending the valuable information to one or more mobile receiving wireless clients to use in making decisions about the ongoing event.

Other aspects of the invention are a method and apparatus used to source, mine and distribute data from the masses of wireless users. In one embodiment, information circulated will be unique to the service offered. The methodology ensures through the lifecycle of the data used that the value of the information is a function of time. As the time elapses, the value of the data decreases in importance. The service utilizes data that is inversely proportional to time in terms of the value of data.

In one embodiment, the trigger mechanisms form an integral part of the system as they provide the ease of use aspect to the customers. However, the trigger mechanisms are unique to the type of service. Accordingly, this invention covers the methodology of thresholds as trigger mechanisms. Any time a device is programmed to initiate a call to request data based on any pre-defined criteria, it would mean that a threshold has been defined and used.

In one embodiment, components of the entire system include a server infrastructure, a mobile client, specific application of the service, and any (optional) attached specialized devices. The mobile phone will provide the necessary information either directly to a customer or to a specialized device that may calculate an appropriate solution for the customer. The core part of the method is that the source data comes from the client, specifically from the mobile device or from the specialized device attached to it. The server side has an application running that is designed to derive information from the data source of a single client or multiple clients. Once the data is derived, it is available for broadcast or on a request basis from the clients. The data is released in real-time or slightly time-shifted as long as the time does not impact the value of data.

Further aspects of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a simple block diagram of an embodiment of a server-mobile client system of the invention.

FIG. 2 is a simple block diagram of an embodiment of the server of the invention with the different types of clients providing data.

FIG. 3 is a flowchart of an embodiment of a method of the invention to process data received from clients.

FIG. 4 is a simple block diagram of the types of data collected.

FIG. 5 shows an embodiment of a system for carrying out the present invention, including specialized equipment that can be attached to the system to derive more functionality.

FIG. 6 shows an embodiment of a data flow lifecycle of the present invention, illustrating how a mobile client interacts as a source and subsequently benefits from the calculations of the server.

FIG. 7 is a flowchart of an embodiment of a method of the invention for uploading information from the client to the server when a threshold is reached.

FIG. 8 is a block diagram of an embodiment of apparatus of the invention for uploading information from the client to the server when a threshold is reached.

### DETAILED DESCRIPTION OF INVENTION

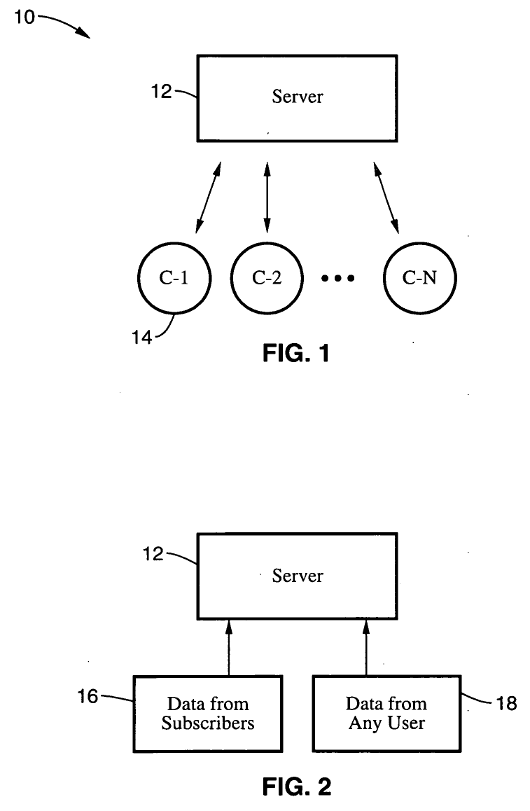

Referring more specifically to the drawings, for illustrative purposes the present invention is embodied in the method and apparatus generally shown in FIG. 1 through FIG. 8. It will be appreciated that the apparatus may vary as to configuration and as to details of the parts, and the method may vary as to its particular implementation, without departing from the basic concepts as disclosed herein.

The invention is directed towards the delivery of wireless informational services to people so they can gain efficiencies in their daily management of time and work. It provides a system and method to deliver time sensitive data, specific to each individual or group, depending on their current scenario. It mines relevant data from the many events that people engage in and provides information related to its efficiencies to other users or agents who may be headed to the same events so they can make appropriate decisions in the interest of service, time and money. When this invention is put in perspective with the economies of scale, it becomes of vital need to the masses whose lives are traversed by a multitude of events. The overall collective efficiency then gained could certainly impact the gross domestic product of an entire country.

The system is set up so that it receives data from a very large pool of clients. FIG. 1 generally illustrates a server-mobile client system 10 of the invention. System 10 includes a server 12 and a plurality of mobile clients 14 (C-1, C-2, . . . C-N). The mobile clients 14 are wireless device users, and are in wireless communication with server 12. Any wireless data communications device can be used; voice communication is not required.

When collecting the source data from the clients, the system can be set up to (a) only accept data from a set of clients that subscribe to the service, or (b) allow any user to upload data, or (c) any combination of (a) and (b).

Allowing a user to upload data would ensure greater quality as data is mined in real time and transmitted back. As shown in FIG. 2 server 12 may receive data from subscribers 16 and from any users 18.

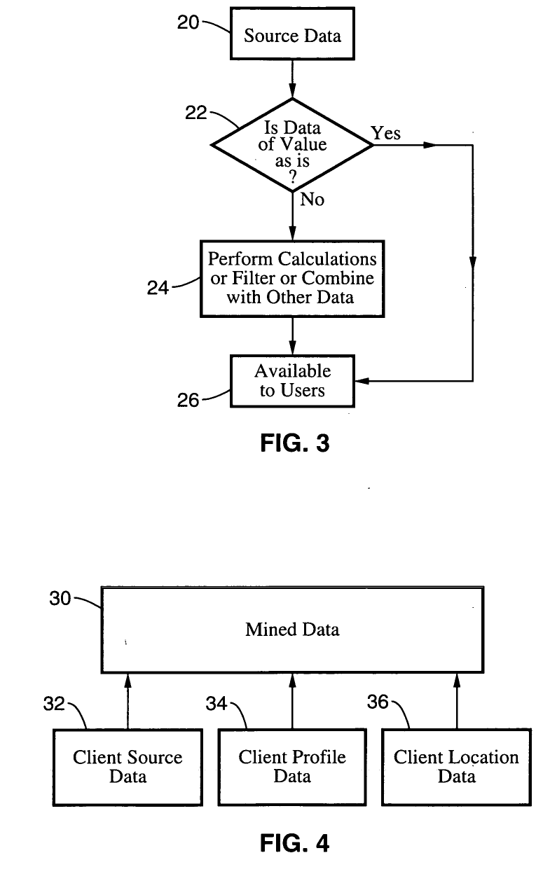

The data collected from the sources may be of a) immediate value without any data calculation or filtration, b) may need to be combined with data from other clients before it has any value, and c) any combination of a) and b). FIG. 3 illustrates a method for processing source data 20. The source data 20 received by the server from the clients is tested to determine if it is of value as is, step 22, using appropriate criteria for the type of data. If it is valuable as is, then it can be made available to users. If it is not valuable as is, then calculations are performed on the data or it is filtered or combined with other data to provide valuable information, step 24. This information is then made available to users, step 26.

The server is set up to receive a) the unique source data provided by the clients, and b) the profile attributes of the client, and/or c) location based information. FIG. 4 illustrates that the mined data 30 received by the server from the clients is made up of the three different types: client source data 32, client profile data 34, and client location data 36. By using any combination of the received data coupled with any necessary calculations and statistical analysis, the data can be immediately transformed into information that in turn is distributed back to the clients.

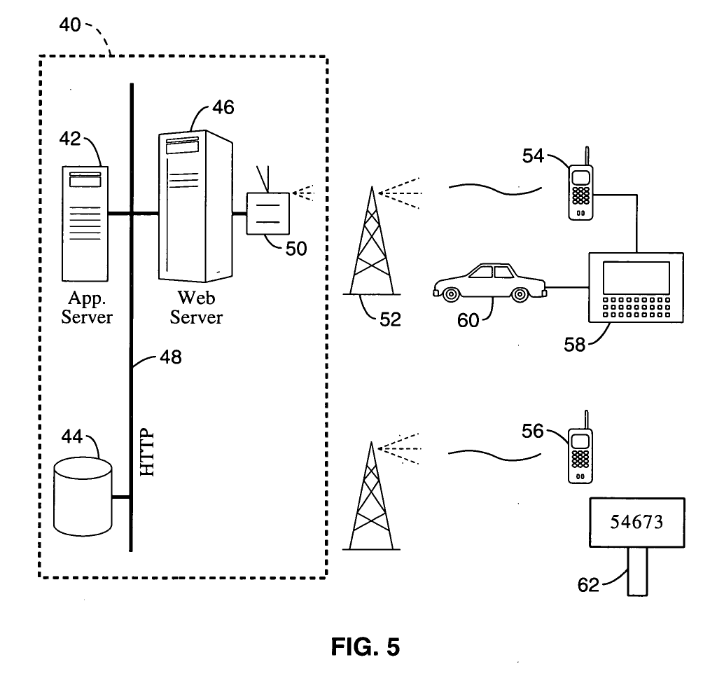

As shown in FIG. 5, a server (host) system 40 is made up of an application server 42, a data storage unit 44, and a web server 46, that are connected by a bus 48. Web server 46 operates the web services for the system while application server 42 operates other functions, e.g. software for data analysis. A modem 50 is connected to web server 46 to allow wireless communication between server system 40 and its clients. A plurality of antennas 52 are provided for use in transmitting and receiving signals to and from the clients. Modem 50 allows web server 46 to communicate with a plurality of wireless (users) clients, e.g. wireless telephones 54, 56. The components are per se well known in the art and are not further described. The particular configuration shown is for illustrative purposes only; any configuration that can perform the necessary functions to carry out the invention could be used.

An example of the usage of this invention is to monitor traffic flow and advise cars about just in time congestion. In FIG. 5, a GPS system 58 is attached to a car 60 and also to wireless phone 54. It now has the capability to upload vehicle speed and location information to the server system 40. The server system 40 in response can return instant information regarding traffic congestion on the route the car is taking. The GPS system 58 can now use this information against its map and chart out an alternative route. When hundreds and thousands of cars start doing the same, the traffic begins to flow in the most optimized manner through the road system.

FIG. 5 also shows another scenario where a mobile phone 56 can call into a number listed at a sign 62. An example of this is entering a queue at an airline ticket counter. When the user enters, he or she can make a call to the given number. The server will record the time stamp and the phone number of the caller. When the user reaches the counter, the user may give his or her phone number to the agent and thus one would know in real time how long a wait there is at a particular ticket counter. Another scenario presents itself at theme parks. Buy a ride ticket and call into a number and enter a code from the ticket. When an opportunity comes for the ride, the customer could be called. Another scenario for theme parks is to monitor the pedestrian traffic similar to the scheme used for road traffic. This will provide customers with information regarding the wait times at different rides to optimally route them to their next adventure.

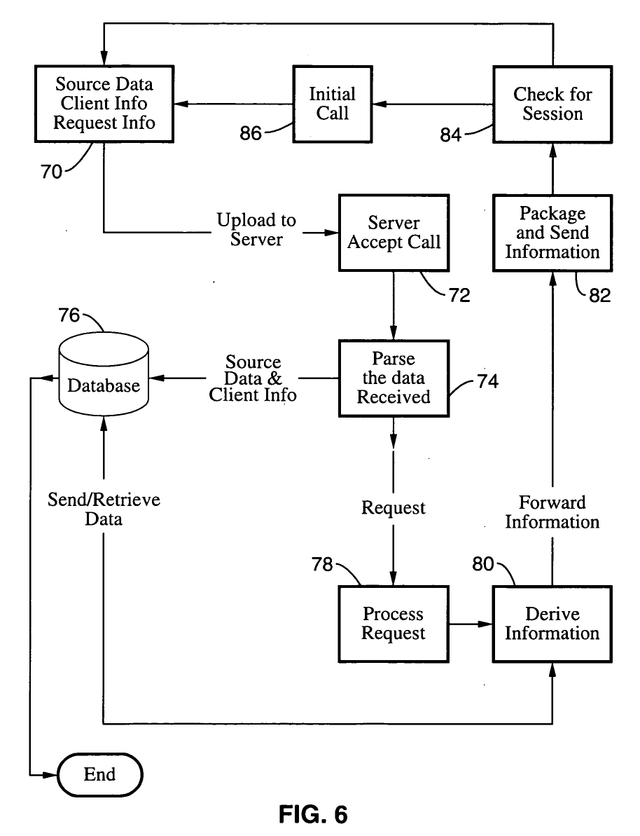

FIG. 6 illustrates the method used in such a service. In step 70, the client calls into the server and uploads any combination of the following data: (A) source data depending on the type of the service, (B) client information or information about itself such as phone number, location, time stamp, etc., and (C) a request for any information from the service. The server accepts the call, step 72, and parses the received data, step 74, into (a) source data and client info, or (b) requests. The source data/client info is stored in a database, step 76. Any client requests are evaluated and processed, step 78.

In step 80, an application related to the service uses the data from step 76 to create information of value. The trigger to activate step 80 is the processed request of the client in step 78. Information relevant to a client is packaged appropriately at step 82 and sent out. Step 84 determines whether the initial call by the client is still ongoing. If the initial call is still ongoing, step 86, data is returned within the session of the upload call. Otherwise, step 84 will dial back with a different session to return the requested data.

The invention may include, but is not limited to, the following features:

1. The data that is provided to the clients is also sourced from the same segment or group of clients. In other words the clients providing the source data are also customers of that data.

2. The data provided by the clients is processed and information is relayed back to the customers within a length of time such that the value of the information is not lost. For example, data would be queued against a timescale. If a minute timescale is chosen, then there is a mined data entry every minute. When a request for info is processed, the latest data from the last minute entry is sent. The timescale can be dynamically managed depending on the nature of the situation it is addressing. For example, if it is responding to a line at a ticket counter for a flight, a timescale of ten minutes would be used three hours prior to the flight then reduced as it time approaches closer to departure.

3. Specialized equipment attached to the mobile unit is used to initiate upload of information when the specialized equipment hits certain pre-programmed thresholds. For example, if there is interest in monitoring traffic jams, then a vehicle traveling beyond a speed of forty miles per hour need not upload any data. These thresholds are used to eliminate noise in data and maintain sanity of the system.

4. The mobile client will carry any request parameters while uploading source data. For example, a subscriber while participating in uploading its vehicle speed may request speed information on multiple routes leading to it destination.

5. Mobile clients are provided with call in information that is pre-associated with an event. For example, if you have a flight reservation, you can send in custom alarm points for the system to provide information to you (e.g., inform me about the security check in line every ten minutes starting two hours prior to my flight).

6. Customers are provided with any specialized mobile device that can be used to input source data. Such mobile devices would typically be wired and wireless data communication devices.

7. Filtered information is provided to the client based on location, destination, time and direction of travel.

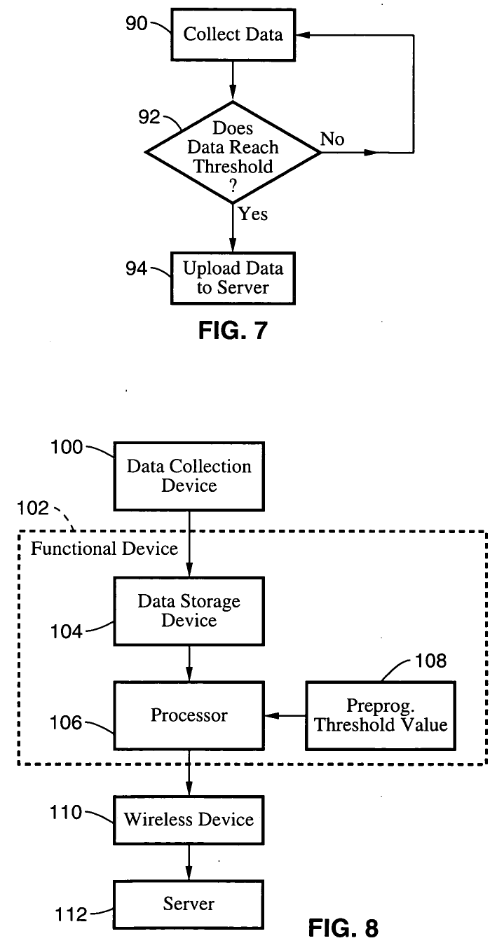

The uploading of information from the client to the server when a threshold is reached is illustrated in FIG. 7 and FIG. 8. FIG. 7 shows a method in which data is collected by a client, step 90. The data is tested to see if it has reached a threshold, step 92. If the data has not reached a threshold, the client continues to collect data, step 90. If the data has reached the threshold, the client uploads the data to the server, step 94. FIG. 8 illustrates an associated apparatus, which includes a data collection device 100 of the client. Data from data collection device 100 is input into data storage device 104 of the client's functional device 102. Processor 106 in functional device 102 processes the data from data storage device 104 and compares it to a preprogrammed threshold value 108. When the data reaches the threshold, it is output from the processor 106 to wireless device 110, which transmits the data to the server 112.

The invention thus provides a system that uses mobile phones to penetrate the masses, to mobilize or collect data from them, and after the data is analyzed individually or cumulatively, to provide key information for the masses of wireless users. The system is a two-way system, both collecting data from the mobile phone users and delivering information based thereon to mobile phone users. The data and information are generally time sensitive and the process operates within the time frame of value of the information.

In one illustrative application, the system is used to provide current traffic information. When traveling by car, wireless users upload their vehicle speed and location coordinates. When this data is analyzed cumulatively from all the subscribers, traffic congestion patterns are deciphered and transmitted back to individual wireless users, depending on their location. Devices attached to such services can engage in discovering a new route to gain efficiency in time of travel.

In another application, a company utilizes this service system to better serve its customers by collecting and providing information about waiting time. For example, when a customer enters an airline ticketing queue, a board shows a telephone number where the user can send an SMS message. When the customer reaches the ticketing counter, the agent can ask for the user's phone number and enters it into the computer. A server system that communicates with the mobile user as well as the agent's computer can calculate the time it took the customer to reach the ticketing counter. The information now can be broadcast to incoming customers who can plan to allot the necessary time and/or the information can be used by airline management to make decisions about closing or opening ticketing counters. Similarly the system could be used in a theme park to obtain and provide information about waiting times or even to schedule times.

The commonality between all these applications is that the data source is the common wireless user. In one case the user is a subscriber of a particular service with the necessary equipment related to it. In another case the user is just a customer of a company and happens to be a wireless user. The invention provides a way to tap this unique data source.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present invention, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

What is claimed is:

1. A method, comprising:
obtaining real time source data from one or more mobile sending wireless clients who are approaching or engaged in a particular ongoing event;
processing the real time source data obtained from the one or more mobile sending wireless clients to produce valuable information relating to the ongoing event; and
sending the valuable information to one or more mobile receiving wireless clients to use in making decisions about the ongoing event.

2. A method as recited in claim 1, wherein the one or more mobile sending wireless clients and the one or more mobile receiving wireless clients belong to a common group of clients.

3. A method as recited in claim 2, wherein the common group of clients are subscribers to a service.

4. A method as recited in claim 1, wherein the source data and valuable information are time sensitive.

5. A method as recited in claim 4, wherein the value of the source data and valuable information are inversely proportional to time.

6. A method as recited in claim 1, wherein the one or more sending mobile wireless clients and the one or more mobile receiving wireless clients use mobile wireless telephones to respectively send source data and to receive valuable information.

7. A method as recited in claim 6, wherein each of the one or more sending wireless clients sends source data when the source data reaches a predetermined threshold.

8. A method as recited in claim 1, further comprising providing each mobile sending client with an associated functional device to upload source data when the functional device hits certain preprogrammed thresholds.

9. A method as recited in claim 1, further comprising providing each mobile sending client with call-in information that is pre-associated with the event.

10. A method as recited in claim 1, wherein processing the source data comprises determining if the source data is valuable as is or needs to be further processed by at least one of calculating, filtering or combining with other data.

11. A method as recited in claim 1, wherein the source data relates to traffic conditions or waiting time in a line.

12. A method as recited in claim 1:
wherein obtaining source data comprises uploading data comprising at least one of source data, client information, and request information to a server; and
wherein processing the source data comprises:
parsing the uploaded data;
storing any source data or client information in a database;
processing any request information; and
producing valuable information from stored source data and client information in response to request information.

13. A method as recited in claim 12, wherein sending the valuable information includes sending the information back during the initial call session or calling back in a different call session.

14. An apparatus, comprising:
a plurality of mobile wireless clients, one or more of which are configured to send real time source data about a particular ongoing event; and
a server configured to receive the source data sent by the one or more clients, process the source data to produce valuable information relating to the ongoing event, and send the valuable information to one or more mobile wireless clients to use in making decisions about the ongoing event.

15. An apparatus as recited in claim 14, wherein at least one mobile wireless client comprises a mobile wireless telephone.

16. An apparatus as recited in claim 15, wherein the server comprises:
a web server, an application server, and a database
a bus connecting the web server, application server, and database; and a modem connected to the web server to allow the web server to communicate with the wireless clients.

17. An apparatus as recited in claim 14, further comprising a functional device associated with each mobile wireless client configured to send source data to the server.

18. An apparatus as recited in claim 17, wherein the functional device is configured to upload source data to the server when the source data reaches certain preprogrammed thresholds.

19. An apparatus as recited in claim 17, wherein the functional device comprises a GPS device.

20. An apparatus, comprising:
means for obtaining real time source data from one or more mobile sending wireless clients who are approaching or engaged in a particular ongoing event;
means for processing the real time source data obtained from the one or more mobile sending wireless clients to produce valuable information relating to the ongoing event; and
means for sending the valuable information to one or more mobile receiving wireless clients to use in making decisions about the ongoing event.
